(19) United States
(12) Patent Application Publication
(10) Pub. No.: US 2018/0229355 A1
(43) Pub. Date: Aug. 16, 2018

(54) Texturing Mallet

(71) Applicant: DPG USA Inc., Schaumburg, IL (US)

(72) Inventor: Nikhil Gupta, Schaumburg, IL (US)

(21) Appl. No.: 15/896,200

(22) Filed: Feb. 14, 2018

Related U.S. Application Data
(60) Provisional application No. 62/459,382, filed on Feb. 15, 2017.

(51) Int. Cl. B25D 1/02

(52) U.S. Cl. CPC B25D 1/02; B25D 2250/00

(57) ABSTRACT

A hammer is provided having two faces, capable of producing a very wide variety of patterns. One face has a single dome centered in an otherwise un-textured field having a slight curvature, which eases the metalworker's ability to apply only the desired design of a single dome. The dome has an ellipsoidal surface with a diameter at its base of ⅛″ to about ¼″ and a height of from about 3/16- 5/16″. The very tip of the ellipsoid has a radius of curvature from about 0.010-0.015″ while the radius of curvature adjacent the intersection with the body is from about 0.035 to 0.070″. The other face has a similar gently curved field with 3 parallel upraised trapezoidal ridges formed therein, the central ridge having a height between about 0.014-0.020″, the two exterior ridges having a height between about 0.009-0.011″, the central face of all three ridges having a width of about 0.010″, and the included angle between the central face and the inclined sidewalls being about 120°.

### CLAIM FOR PRIORITY

This Non-Provisional patent application is based on U.S. Provisional Patent Application Ser. No. 62/459,382, filed on Feb. 15, 2017, the priority of which is claimed, and the disclosure of which is incorporated by reference.

### BACKGROUND OF THE INVENTION

Decorative metal working is quite popular for producing items of jewelry as well as ornamental metal decorations to be sewn to clothing, bangles, partial covers for books, decorative knickknacks as well as a host of other hobbyist applications. In many cases, the metalworker wishes to impart a decorative texture to the metal piece which is often formed from soft copper, aluminum, bronze, brass or some other malleable metal. One particularly effective way of imparting a decorative texture is to hammer the pattern into the metallic piece with a specialized mallet. In many cases, many hammers will be required to produce the desired effect. To that end, hammers are also sold for texturing having a multiplicity of interchangeable tips to produce a wide variety of designs with one commonly offered combination comprising no less than 9 interchangeable tips.

### SUMMARY OF THE INVENTION

This invention is directed to a hammer capable of producing a very wide variety of patterns without requiring the complication of multiple hammers or multiplicity of interchangeable tips for the hammer. I have found that almost every commonly desired pattern and texture can be produced using a hammer having two faces, one with a single dome centered in an otherwise un-textured field. Typically, the field will have a slight curvature to ease the ability with which the metalworker is able to apply only the desired design without the remainder of the face of the mallet impacting on the work piece. Typically the radius of curvature of the field around the single dome will be several inches, 6 to 12 or 18 inches being suitable. The dome shape chosen for this face of the mallet will typically be elliptical or more precisely an ellipsoidal surface having a diameter at its base of ⅛ inch up to about ¼ inch and a height of from about 3/16 of an inch to about 5/16 inch. Preferably the radius of curvature of the very tip of the ellipsoid will be from about 10 to 15 thousandths of an inch while the radius of curvature adjacent the intersection with the body will be from about 35 to 70 thousandths of an inch. I have found that with these dimensions, amateur metalworkers are able to produce dots having a variety of sizes of desirable definition and without undue effort.

For the other face of the hammer I prefer the same gently domed field with 3 parallel upraised trapezoidal ridges formed therein, the central ridge having a height about between about 14 and 20 thousandths of an inch, the two exterior ridges having a height of between about 9 and 11 thousandths of an inch, the central face of all three ridges having a width of about 10 thousandths of an inch, the included angle between the central face and the inclined sidewalls being about 120 degrees.

Other aspects and advantages of the present invention are described in the detailed description below and in the claims.

### BRIEF DESCRIPTION OF THE DRAWINGS

The invention is described in detail below with reference to the appended drawings, wherein like numerals designate similar parts. In the Figures:

FIG. 1 is a side elevation of the texturing mallet of the present invention.

FIG. 2 is an enlarged schematic perspective illustrating the ridged face of the texturing mallet invention.

FIG. 3 is an enlarged schematic perspective illustrating the domed face of the texturing mallet of the present invention.

FIG. 4 is an enlarged right elevation illustrating the profile of the faces of the texturing mallet of the present invention.

FIG. 5 is an enlarged plan view illustrating the texturing mallet of the present invention.

FIG. 6 is greatly magnified view of the central portion of the domed face of the texturing mallet of the present invention illustrating the dimensions and radius of curvature thereof.

FIG. 7 is a greatly magnified plan view of the ridges on the ridged face of the texturing mallet the present invention illustrating dimensions thereof.

### DETAILED DESCRIPTION OF THE INVENTION

The invention is described in detail below with reference to several embodiments and numerous examples. Such discussion is for purposes of illustration only. Modifications to particular examples within the spirit and scope of the present invention, set forth in the appended claims, will be readily apparent to one of skill in the art. Terminology used herein is given its ordinary meaning consistent with the exemplary definitions set forth immediately below.

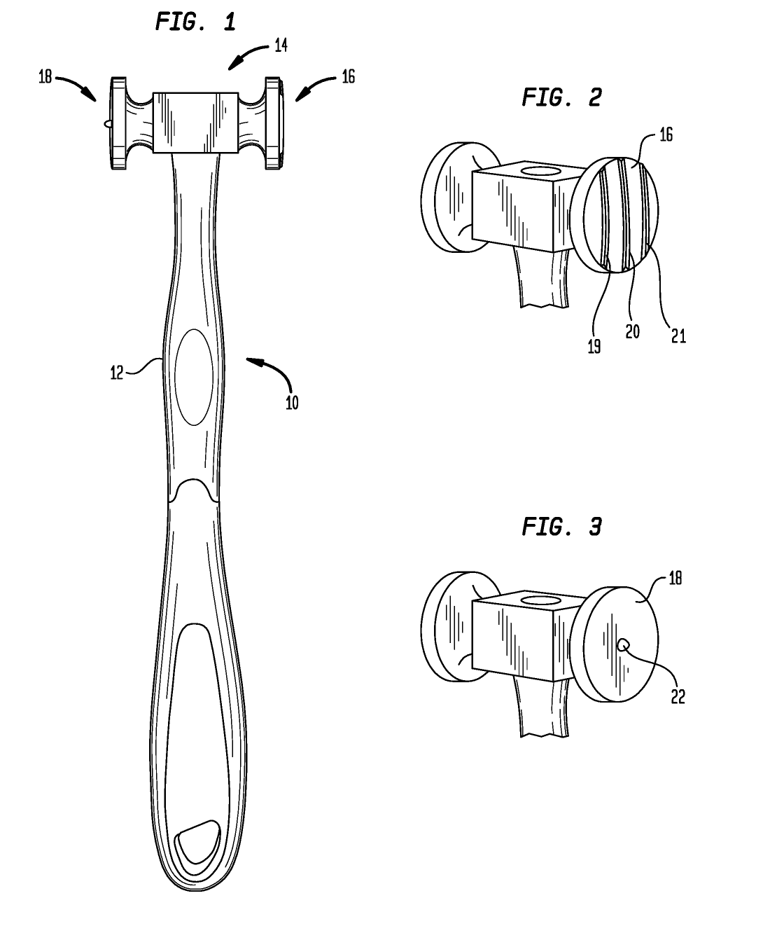

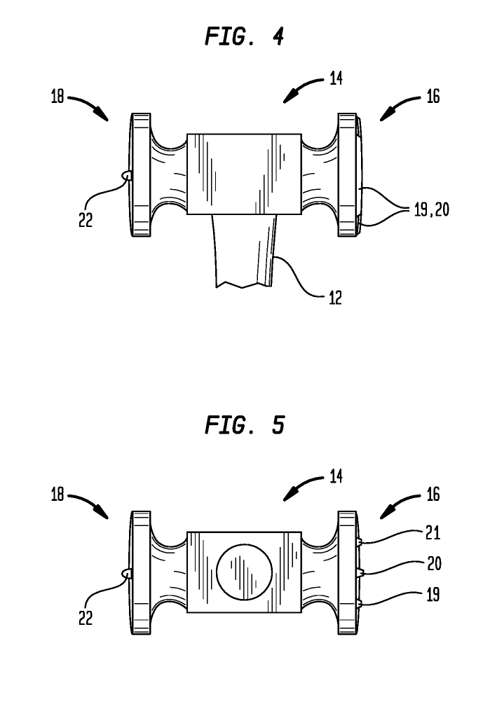

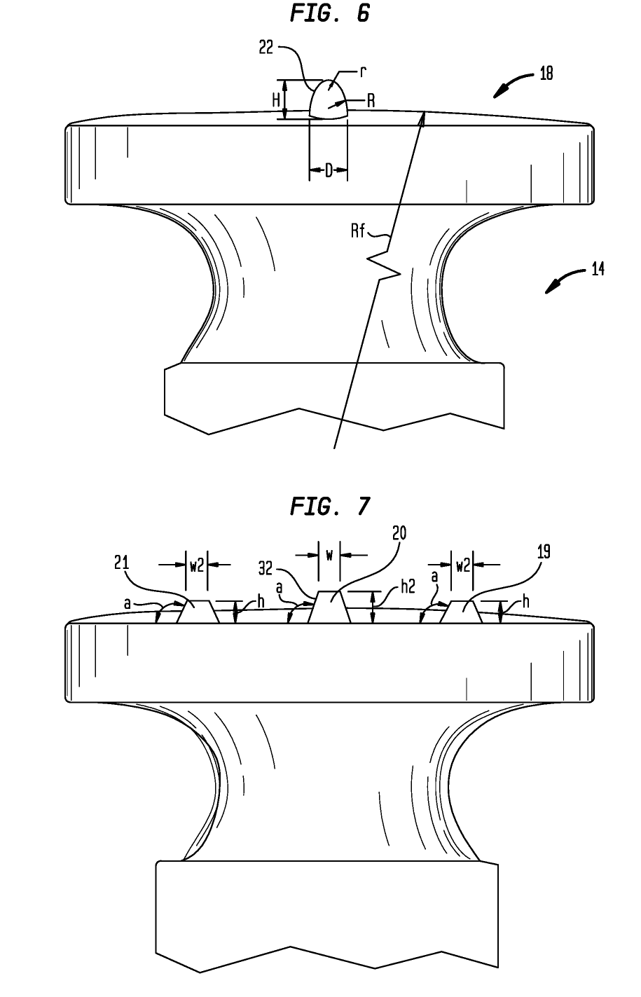

FIG. 1 Illustrates hammer 10 having handle 12 and head 14 having opposed faces 16 and 18 at opposite ends thereof. FIG. 2 illustrates face 16 having three ridges 19, 20 and 21 extending thereacross; while FIG. 3 illustrates face 18 having dome 22 disposed centrally thereupon. FIG. 4 is an enlarged profile view of head 14, while FIG. 5 is a top view of head 14. FIG. 6 is a magnified view of face 18 of head 14 illustrating dimensions of dome 22 as well as radius of curvature “Rf” of generally untextured face 18, while FIG. 7 is a magnified view of face 16 of head 14 illustrating height “h2” and width w of central ridge 20 as well as width “w2” and height “h” of lateral ridges 19 and 21. I have found that artisans are able to obtain excellent results conveniently when base diameter “D” of dome 22 is from about ⅛ to ¼ inch, while height “h” is from about 3/16 to 5/16 inch, radius of curvature “r” of the very tip of dome 22 is from about 0.01 inches to about 0.015 inches, while radius of curvature “R” of the sidewall is from about 0.035 to about 0.070 inch and the overall radius of curvature of face 18 is between 6 inches and 18 inches, more preferably between 6 inches 12 inches. Preferably, height “h” of lateral ridges 19 and 21 is from about 0.009 to 0.011 inch, the height of central ridge 20 is from about 0.014 to about 0.020 inch, the width of each ridge 19, 20, and 21 is about 0.010 inch and the included angle “a” between face 16 and sidewalls 32 is about 120°.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

What is claimed is:

1. A texturing hammer, comprising:
a handle having a head attached thereto, said head having:
a first face having a single dome centered on a generally untextured field having a radius of curvature of between 6 and 18 inches, said dome being ellipsoidal, having a diameter at its base of from about ⅛ inch up to about ¼ inch and a height of from about 3/16 of an inch to about 5/16 inch, the radius of curvature of the very tip of the ellipsoid being from about 10 to 15 thousandths of an inch with the radius of curvature of the ellipsoidal face dome adjacent the intersection with the generally untextured field being from about 35 to 70 thousandths of an inch; and
a second face of the hammer having a generally untextured field having a radius of curvature of between 6 and 18 inches with 3 parallel upraised trapezoidal ridges formed thereupon, the central ridge having a height of between about 14 and 20 thousandths of an inch, the two exterior ridges having a height of between about 9 and 11 thousandths of an inch, the central face of all three ridges having a width of about 10 thousandths of an inch, the included angle between the central face and the inclined sidewalls being about 120 degrees.
